(19) United States
(12) Patent Application Publication
(10) Pub. No.: US 2021/0271766 A1
(43) Pub. Date: Sep. 2, 2021

(54) TRANSACTION INFORMATION MANAGEMENT

(71) Applicant: International Business Machines Corporation, Armonk, NY (US)

(72) Inventors: Adam Yoho, Pflugerville, TX (US); David Yu Chang, Austin, TX (US); Zechariah Hein, Georgetown, TX (US); Paul William Bennett, Round Rock, TX (US); Wilalberto Rodriguez, Austin, TX (US)

(21) Appl. No.: 16/805,908

(22) Filed: Mar. 2, 2020

(51) Int. Cl. G06F 21/60; H04L 9/32; G06F 21/62

(52) U.S. Cl. CPC G06F 21/604; G06F 21/6245; H04L 9/3263

(57) ABSTRACT

Transaction information management is provided. A request for a transaction identifier is received from a first entity to perform a transaction with a user. Transaction information for the transaction determined with the transaction information including authorized entities and sets of personal information of the user available to each of the authorized entities. The transaction information is stored. The transaction identifier linked to the transaction is generated. The transaction identifier is provided to the first entity.

### BACKGROUND

The present disclosure relates to information management, and more specifically, to information management in multi-party transactions.

Online transactions often involve multiple parties. For example, parties to a transaction may include a buyer, a merchant, a payment processor, and a shipper. Typically, the buyer provides their information to the merchant and the merchant shares the relevant information with the payment processor and the shipper.

### SUMMARY

According to embodiments of the present disclosure, a computer-implemented method is provided. The method includes receiving a request for a transaction identifier from a first entity to perform a transaction with a user. Transaction information for the transaction determined with the transaction information including authorized entities and sets of personal information of the user available to each of the authorized entities. The transaction information is stored. The transaction identifier linked to the transaction is generated. The transaction identifier is provided to the first entity.

Further embodiments include a system and a computer program product for performing the method.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of a system for managing information for a transaction according to embodiments.

FIG. 2 depicts an example information flow diagram for generating a transaction identifier according to embodiments.

FIG. 3 depicts an example information flow diagram for using a transaction identifier according to embodiments.

FIG. 4 depicts a flow diagram of an example method for generating a transaction identifier according to embodiments.

FIG. 5 depicts a flow diagram of an example method for exchanging a transaction identifier for user personal information according to embodiments.

FIG. 6 depicts a block diagram of an example computer system according to embodiments.

FIG. 7 depicts a cloud computing environment according to an embodiment of the present disclosure.

FIG. 8 depicts abstraction model layers according to an embodiment of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to transaction information management, and more particular aspects relate to using transaction identifiers for transaction information management. While the present disclosure is not necessarily limited to such applications, various aspects of the disclosure may be appreciated through a discussion of various examples using this context.

Online transactions with merchants typically require a consumer to provide the merchant with personal information such as their name, address, and credit card information. Typically, the merchants themselves do not need access to the information, but instead they need to pass the information to other entities to complete the transaction. For example, the merchant may need to provide a shipping company with the name and address of the consumer to ship merchandise to the consumer. Additionally, the merchant may need to provide a payment processor with the name, address, and credit card information to collect payment for the transaction.

Security breaches can cause a person's personal information to be leaked. Further, consumers may not trust certain merchants with their personal information. Thus, for the security of the consumer's personal information, it may be preferable to limit the sharing of the personal information to only the parties that require the information to perform the transaction. Further, it may be preferable to limit the personal information provided to such parties to only what the party needs to perform their part of the transaction.

Embodiments of the present disclosure provide a method, system, and computer program product for managing personal information for transactions. In embodiments, a user may provide their personal information to a trusted information management provider and the information management provider may distribute the information required to perform a transaction to the entities that require the information while withholding information from parties that is not required to perform the transaction.

Aspects of the present disclosure involve the handling of personal information. It is to be understood that users' personal information will be handled with the consent of the users and will conform with all relevant laws and regulations.

A transaction information management system may be configured to store personal information for a user. In some embodiments, a user may create a profile with the transaction information management system to store their information for future transactions. Alternatively, the transaction information system may collect information from the user for each transaction and discard the information after it is no longer needed for the transaction.

In some embodiments, the use of the transaction information management system is offered to a user by a merchant to complete a transaction. For example, a user may select an item to purchase from an online merchant and the online merchant may indicate to the user that the user can use the transaction information system to manage the transaction. When a user elects to use the transaction information system, the merchant may request a transaction identifier from the transaction information system.

In response to receiving the request for a transaction identifier, the transaction information management system may communicate with the merchant and the user to determine what personal information needs to be shared with what entities in order to complete the transaction. After the user has confirmed the entities and/or the information to be shared with the entities, the transaction information management system may generate a unique identifier and link it to the specific transaction. The transaction information management system may then provide the identifier to the merchant. The merchant may then provide the identifier to other entities that require personal information of the user for the transaction. Each entity may then provide the identifier, along with an entity identification, to obtain the user personal information that is required to perform their part of the transaction.

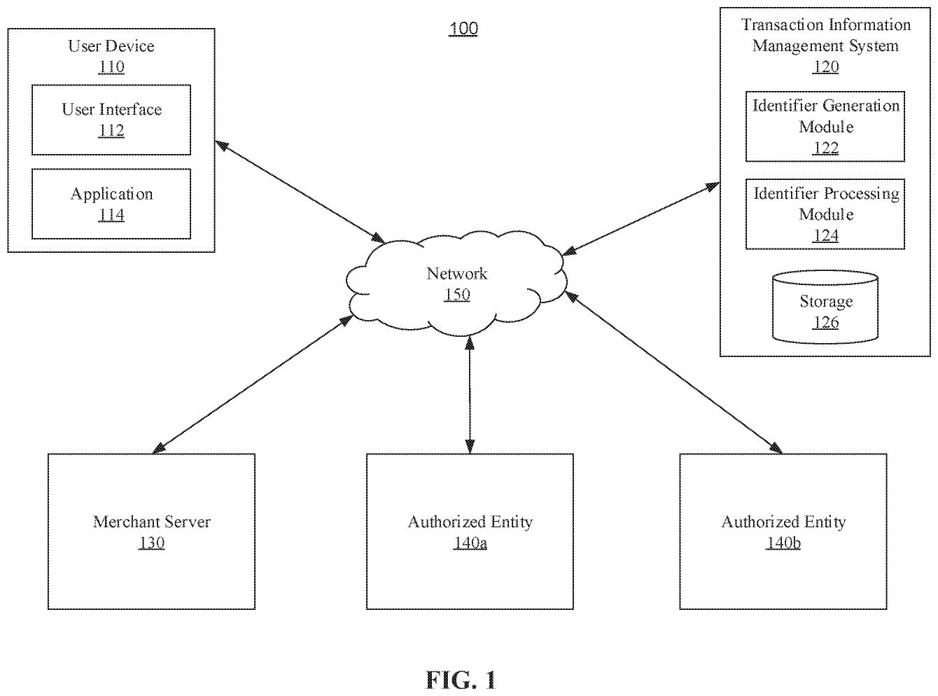

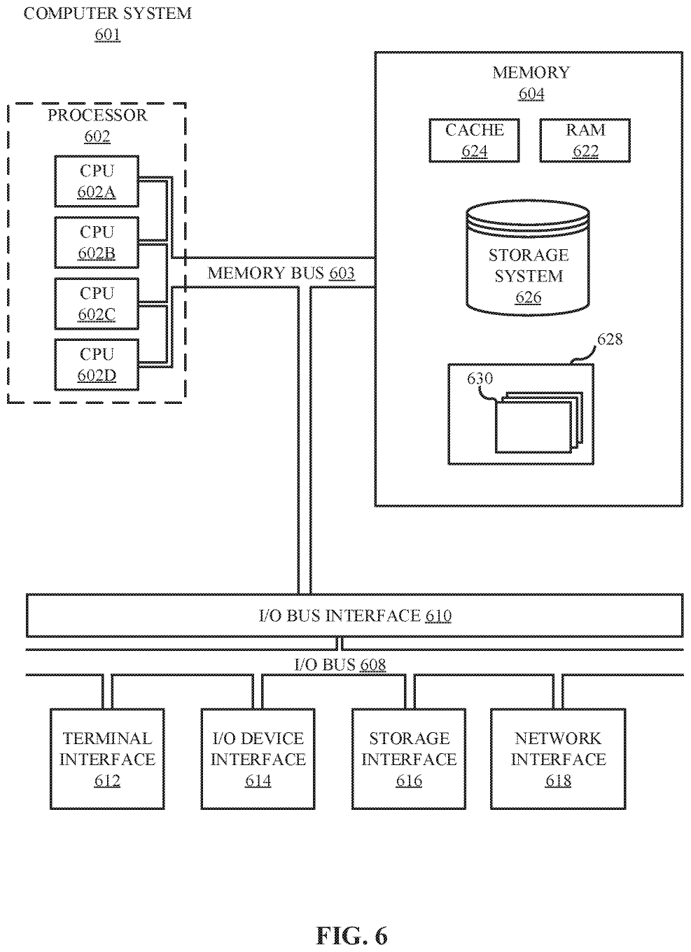

Referring now to FIG. 1, a block diagram of a system 100 for managing information for a transaction is depicted according to embodiments of the present disclosure. System 100 includes user device 110, transaction information management system 120, merchant server 130, and authorized entities 140a-b. Each of the devices and servers may be a computer system such as computer system 601 described in reference to FIG. 6.

Each of the devices and servers may communicate with each other over a network 150. In an example embodiment, the network 150 may be the Internet, representing a worldwide collection of networks and gateways to support communications between devices connected to the Internet. The network 150 may include, for example, wired, wireless, or fiber optic connections. In alternative embodiments, the network 150 may be implemented as an intranet, a local area network (LAN), or a wide area network (WAN). In general, the network 150 can be any combination of connections and protocols that will support communications between the user device 110, the transaction information management system 120, the merchant server 130, and authorized entities 140a-b.

The user device 110 may include user interface 112 and an application 114. A user may use user interface 112 and application 114 to initiate a request to perform a transaction with a merchant via merchant server 130. User interface 112 may be any combination of components allowing for user interaction with user device 110. For example, user interface components may include a keyboard, mouse, touchscreen, microphone, etc. Application 114 may be any computer application such as, for example, an internet browser or a merchant-specific application.

In response to the request to perform the transaction, merchant server 130 may communicate the option to use an information management system to the user. For example, merchant server 130 may communicate with user device 110 to cause application 114 to provide the user with option to select, using user interface 112, the use of the transaction information management system. In response to receiving a selection from the user to use the transaction information management system, merchant server 130 may request a transaction identifier from transaction information management system 120 to complete the transaction with the user. In some embodiments, the merchant may further indicate the personal information needed to perform the transaction. For example, the merchant may indicate that the name, shipping address, and credit card information for the user is needed in order to perform the transaction. In some embodiments, the merchant may further define specific entities that they want to use to perform the transaction such as, for example, a shipper and a payment processor. In some embodiments, the merchant may specify the specific personal information that will be provided to each entity for the transaction.

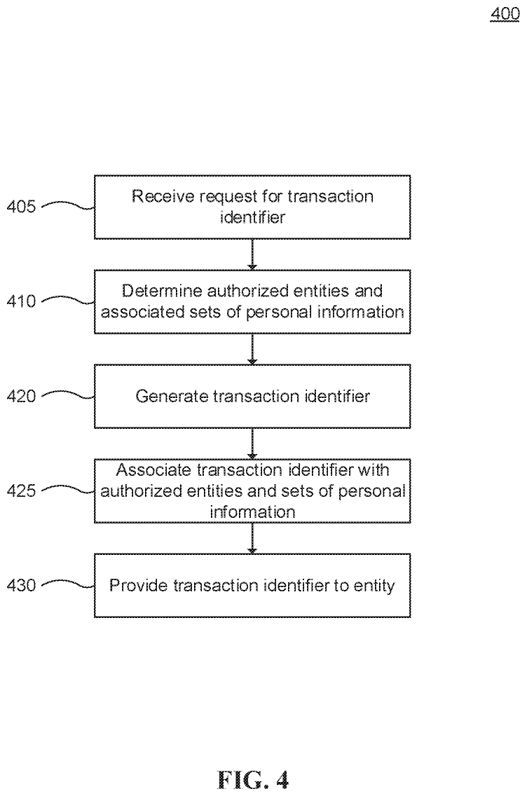

The modules described herein may be implemented using a combination of hardware and software. Transaction information management system 120 may include an identifier generation module 122. Identifier generation module 122 may be configured to perform a method such as method 400 described in reference to FIG. 4. Identifier generation module 122 may be configured to collect transaction information, collect the personal information for the user, and generate the identifier for the transaction. In response to receiving a request for a transaction identifier, identifier generation module 122 may collect transaction information through communication with some combination of the user device and the merchant server. In embodiments where the merchant has specified the specific entities and personal information required, the identifier generation module may prompt the user (e.g., via application 114 of user device 110) for confirmation or changes to the entities and/or information. In response to receiving changes to the entities and/or information, the identifier generation module may communicate with merchant server 130 to confirm the changes.

Once the transaction information has been collected and/or confirmed, the identifier generation module 122 may be configured to collect the personal information for the user. In some embodiments, identifier generation module 122 may prompt the user (e.g., via application 114 of user device 110) for the personal information required for the transaction. In response, identifier generation module 122 may receive personal information for the user and store it in a storage 126. Storage 126 may be any combination of computer components and recording media for retaining digital data. In some embodiments, the personal information for the user may be stored in a user profile in storage 126 and identifier generation module 122 may determine whether the user profile contains the required personal information for the transaction. If the user profile does not contain the required personal information, the user may be prompted to provide the missing information.

The identifier generation module 122 may be configured to generate a transaction identifier and associate it with the transaction information. The transaction identifier may be a unique string of values that the information management system maps to a specific transaction. The transaction identifier itself may be devoid of personal information for the user. For example, the transaction identifier may be a random string of values. The transaction identifier may be stored with the transaction information such that the transaction identifier may be used to locate the transaction information. In some embodiments, the required personal information may also be stored with the transaction identifier and transaction information. In some embodiments, the transaction identifier is stored with a pointer to a user's profile such that the transaction information and user profile may be used in conjunction when identifying user information for a transaction.

The identifier generation module 122 may be configured to communicate the identifier to merchant server 130. In some embodiments, the identifier may be communicated as a string of values. In some embodiments, the identifier may be encoded within an image or data object. For example, the identifier generation module may encode the transaction identifier within a machine-readable image such as a barcode. For example, the transaction identifier may be encoded within image containing a matrix barcode such as a QUICK RESPONSE (QR) code. In some embodiments, the machine-readable image may be encoded such that the machine reading the image extracts the unique identifier. In some embodiments, the machine-readable image may be encoded such that the machine reading the image is directed to a website for receiving a user's personal information. For example, a computing device may scan a QR code that causes a web browser to open a specific uniform resource locator (URL) address that is linked to the specific transaction. In some embodiments, transaction identifier may be contained within a data object containing some or all of the information for the transaction, but the information for the transaction is opaque to all parties other than the transaction information management system using, for example, encryption techniques. In some embodiments, the identifier generation module 122 may further communicate the identifier to the user for tracking the transaction.

The merchant may provide the identifier to authorized entities that are used for the transaction. For example, authorized entity 140a may be a payment processor and authorized entity 140b may be a shipper. The merchant may communicate the transaction identifier to entities electronically or may physically provide the transaction identifier to entities. For example, the merchant may electronically communicate the identifier and an amount for the purchase from merchant server 130 to authorized entity 140a, a payment processor. In another example, the merchant may place a shipping label with the transaction identifier on a box containing merchandise for the transaction and physically provide the box to authorized entity 140b, a shipper.

The authorized entities 140a-b may communicate the transaction identifier and entity identification information to transaction information management system 120 to receive personal information for the user. In some embodiments, an authorized entity may provide the transaction identifier by communicating the transaction identifier itself to the transaction information management system. For example, by entering the transaction identifier into an input field on a website provided by the transaction information management system. As another example, the authorized entity may communicate a data object containing the transaction identifier to the transaction information management system. For example, an authorized entity may communicate a data object containing the transaction identifier to the transaction information management system. In some embodiments, communicating the transaction identifier includes accessing a network address associated with the identifier. For example, where the identifier is embedded within a QR code configured to direct a machine to access a URL containing the identifier, the entity may communicate the transaction identifier by accessing the URL containing the identifier.

In response to receiving the entity identification information, identifier processing module 124 may be configured to verify the entity using the entity identification information. The entity identification may be any data that can be used by the transaction information management system to verify the entity. The entity identification may be used to verify the identity of the entity using any suitable authentication techniques. In some embodiments, the entity identification may be a login ID and password that is verified against a login ID and password in storage 126. In some embodiments, the entity identification may be digital certificate issued by the transaction management system or other trusted issuer.

The transaction identifier and entity identification may be received concurrently, or one may be received one before the other. For example, the transaction information management system may receive the transaction identifier from the entity and then request that the entity provide their entity identification. Alternatively, the transaction information management system may receive the entity identification from the entity and then prompt the entity for the transaction identifier.

Once the transaction identifier has been received and the identity of the entity has been verified, the identifier processing module 124 may determine the personal information of a user that the entity is authorized to receive for the transaction. The identifier processing module 124 may access the transaction data for the transaction associated with the transaction identifier in storage 126. Using the transaction data, identifier processing module 124 may determine what personal information the entity is authorized to receive and communicate that information to the entity. In some embodiments, the personal information may be communicated over network 150.

Once the personal information has been communicated to the entity, identifier processing module 124 may create a record. The identifier processing module may store a record for the transaction in storage 126. For example, a transaction ledger associated with the transaction identifier may be stored in storage 126, and the identifier processing module may be configured to add a new record to the ledger. The record may include the entity, the information provided to the entity, and the time and date that the information was provided to the entity.

In some embodiments, identifier processing module 124 may invalidate the entity from further attempts to access the personal information. For example, the identifier processing module may edit the transaction data in storage 126 to remove the entity as an authorized entity.

In some embodiments, identifier processing module 124 may also be configured to receive a transaction identifier and a user identification from a user. The user identification may be any data that can be used by the transaction information management system 120 to verify the identity of the user, similar to the entity identification. In response to receiving the transaction identifier and verifying the user, the identifier processing module may provide the transaction data and/or records of the personal information shared as part of the transaction (e.g., records in the ledger for the transaction).

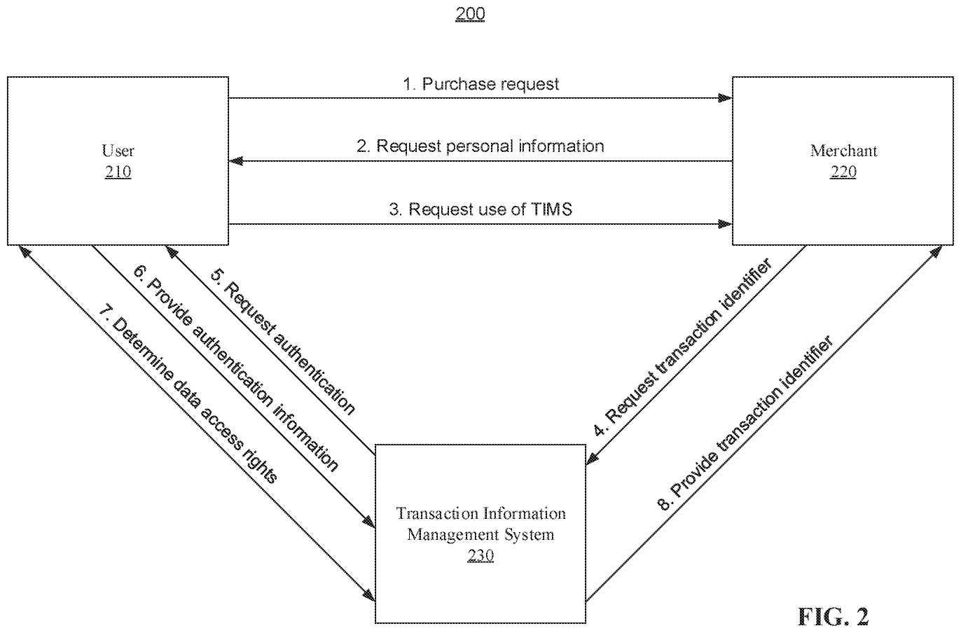

Referring now to FIG. 2, an example information flow diagram 200 for generating a transaction identifier is depicted according to embodiments. As depicted, the information flow may begin with user 210 making a purchase request with a merchant 220. In response to the purchase request, merchant 220 may request personal information from user 210 to perform the transaction. In response to the request for personal information, user 210 may request that the entity use a transaction information management system.

Merchant 220 may request a transaction identifier from transaction information management system 230. In response to receiving the request for the transaction identifier, transaction information management system 230 may request authentication information from user 210. User 210 may provide the authentication information to transaction information management system 230. In response to authenticating user 210, transaction information management system 230 may determine data access rights for entities for the personal information of user 210. When the access rights have been determined, transaction information management system 230 may generate a transaction identifier and provide the identifier to merchant 220.

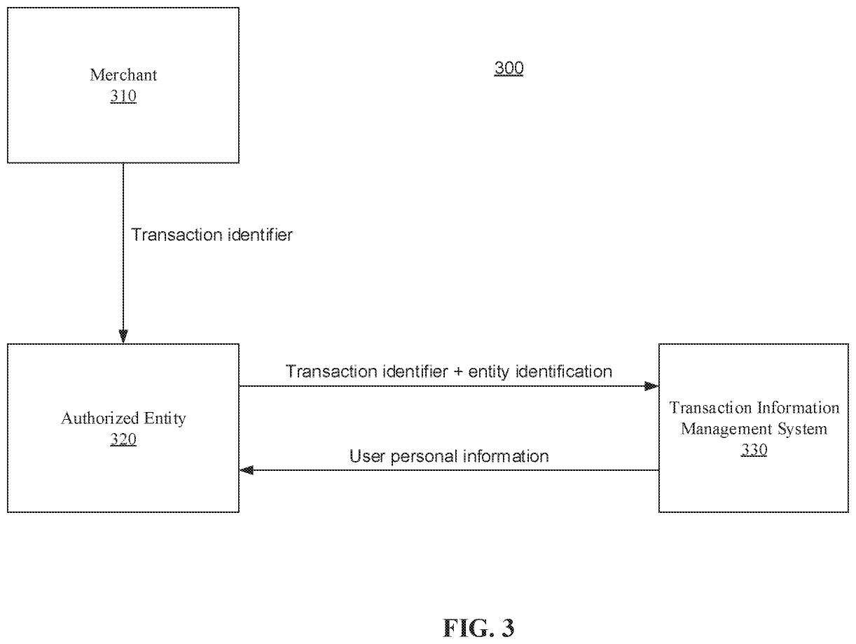

Referring now to FIG. 3, an example information flow diagram 300 for using a transaction identifier is depicted according to embodiments. As depicted, a merchant 310 may provide a transaction identifier to an authorized entity 320. The authorized entity 320 may provide the transaction identifier and entity identification information to transaction information management system 330. In response to verifying the identity of the entity, transaction information management system 330 may provide personal information for a user to authorized entity 320.

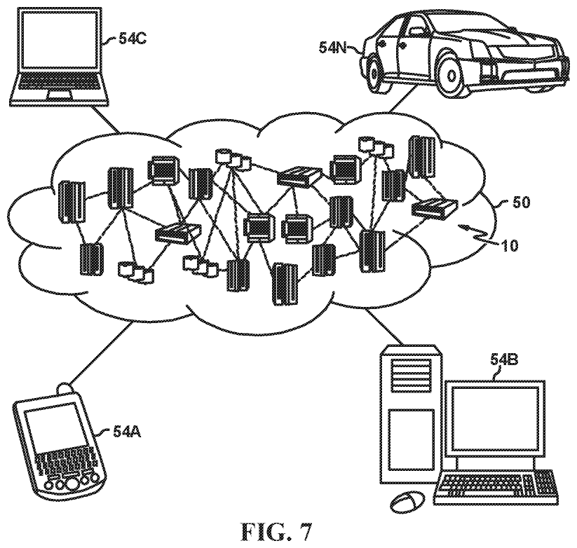

Referring now to FIG. 4, a flow diagram of an example method 400 for generating a transaction identifier is depicted according to embodiments. Method 400 is described herein as being performed by a transaction information management system such as transaction information management system 120 described in reference to FIG. 1. However, method 400 may be performed by any suitable computing system. In some embodiments, method 400 is performed by a computer system such as, computer system 601 described in reference to FIG. 6. In some embodiments, method 400 may be performed in a cloud computing environment such as, for example, cloud computing environment 50 described in reference to FIG. 7.

Method 400 may begin with a transaction information management system receiving a request for a transaction identifier from a first entity for a transaction with a user, per 405. The transaction information management system may receive the request from an entity computing system over one or more networks. In some embodiments, the request is accompanied by an indication of the user's personal information that is needed for the transaction. In some embodiments, the request may further be accompanied by an indication of entities that will need access to the user's personal information and an indication of the specific user personal information that each entity needs access to.

In response to receiving the request for the transaction identifier, the transaction information management system determines authorized entities and associated sets of personal information for the transaction, per 410. In some embodiments, the transaction information management system communicates with the user to determine the data access rights for the transaction. For example, the information management system may communicate to the user the initial entities and personal information specified by the entity requesting the transaction identifier and receive confirmation or changes from the user. In some embodiments, this may also include collecting the user personal information for the transaction.

In some embodiments, the transaction information management system may maintain user profiles with personal information that has been provided by users such that the information may be used for different transactions. In these embodiments, the transaction information management system may request authentication information from the user to verify their identity and allow the transaction information management system to use their stored information for the transaction.

In some embodiments, the transaction information management system requests the required personal information from the user for each transaction. In these embodiments, the transaction information management system may store the information only as necessary for the transaction before discarding the information.

The transaction information management system may generate a transaction identifier per, 420. As used herein, a transaction identifier is data that the transaction information management uses to identify a specific transaction. The transaction identifier may be an opaque string that the information management system maps to a specific transaction. The transaction identifier itself may be devoid of personal information for the user. For example, the transaction identifier may be a random string of values that is generated by the transaction information management system.

In some embodiments, the transaction identifier may be encoded within a machine-readable image such as a barcode. For example, the transaction identifier may be encoded within image containing a matrix barcode such as a QUICK RESPONSE (QR) code. In some embodiments, the machine-readable image may be encoded such that the machine reading the image extracts the unique identifier. In some embodiments, the machine-readable image may be encoded such that the machine reading the image is directed to a website for receiving a user's personal information. For example, a computing device may scan a QR code that causes a web browser to open a specific uniform resource locator (URL) address that is linked to the specific transaction.

In some embodiments, transaction identifier may be contained within a data object containing some or all of the information for the transaction, but the information for the transaction is opaque to all parties other than the transaction information management system using, for example, encryption techniques.

The transaction information system may associate the transaction identifier with authorized entities and associated sets of personal information, per 425. In some embodiments, the transaction identifier may be used as a file name that contains the transaction information for the associated transaction.

The transaction information management system may provide the transaction identifier to the entity that requested the transaction identifier, per 430. For example, the transaction information management system may communicate the transaction identifier over one or more networks to the entity computing system that requested the transaction identifier. In some embodiments, the identifier may be transmitted as an opaque string of values. In some embodiments, the transaction identifier may be provided to the entity within a machine-readable image as discussed herein.

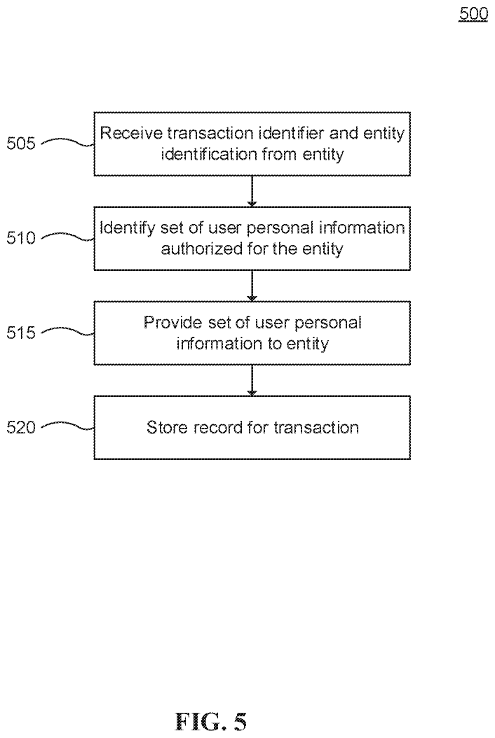

Referring now to FIG. 5, a flow diagram of an example method 500 for exchanging a transaction identifier for user personal information is depicted according to embodiments. Method 500 is described herein as being performed by a transaction information management system such as transaction information management system 120 described in reference to FIG. 1. However, method 500 may be performed by any suitable computing system. In some embodiments, method 500 is performed by a computer system such as, computer system 601 described in reference to FIG. 6. In some embodiments, method 500 may be performed in a cloud computing environment such as, for example, cloud computing environment 50 described in reference to FIG. 7.

Method 500 begins with a transaction information management system receiving a transaction identifier and entity identification information from an entity, per 505. The transaction identifier and entity identification may be received concurrently, or one may be received one before the other. For example, the transaction information management system may receive the transaction identifier from the entity and then request that the entity provide their entity identification. Alternatively, the transaction information management system may receive the entity identification from the entity and then prompt the entity for the transaction identifier.

The transaction identifier may be received in various ways according to different embodiments. In some embodiments, the entity may communicate the transaction identifier to the information management system over one or more networks. In some embodiments, the transaction information management system may receive the transaction identifier by receiving access to a network location using the identifier. For example, the entity may access a URL that includes the identifier. The entity identification may be any data that can be used by the transaction information management system to verify the entity. The entity identification may be used to verify the identity of the entity using any suitable authentication techniques.

In response to receiving the transaction identifier and verifying the entity, the transaction information management system may identify a set of user personal information that the entity is authorized to receive, per 510. In some embodiments, the transaction information management system may use the identifier to locate transaction data for the transaction in storage and determine the personal data that the entity is authorized to receive in the transaction data. The personal data may be located in the same storage location or the personal data may be located in a separate location such as a user profile.

The transaction information management system may provide the set of user personal information to the entity, per 515. In some embodiments, the transaction information management system communicates the user personal information to the entity over one or more networks. In some embodiments, the transaction information management system may invalidate the ability of the entity to access the personal information in future attempts.

The transaction information management system may store a record for the transaction, per 520. The transaction information management system may store a record in a transaction ledger for the transaction. The record may include, for example, identification of the entity, personal information communicated, and time/date of the communication.

Referring now to FIG. 6, shown is a high-level block diagram of an example computer system 601 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache.

System memory 604 may include computer system readable media in the form of volatile memory, such as random access memory (RAM) 622 or cache memory 624. Computer system 601 may further include other removable/non-removable, volatile/non-volatile computer system storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 may include at least one program product having a set (e.g., at least one) of program modules that are configured to carry out the functions of various embodiments.

One or more programs/utilities 628, each having at least one set of program modules 630 may be stored in memory 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Program modules 630 generally perform the functions or methodologies of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

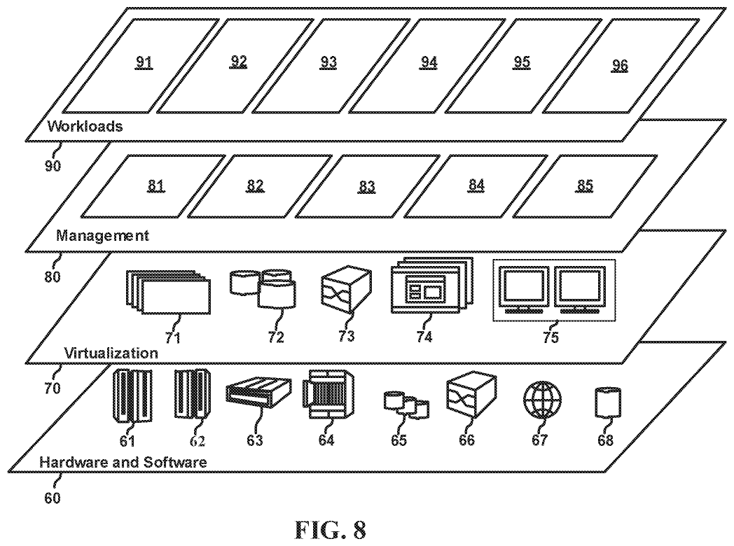

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and transaction information management 96.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a request for a transaction identifier from a first entity to perform a transaction with a user;
determining transaction information for the transaction, the transaction information including authorized entities and sets of personal information of the user available to each of the authorized entities;
storing the transaction information;
generating the transaction identifier linked to the transaction; and
providing the transaction identifier to the first entity.

2. The method of claim 1, further comprising:
receiving the transaction identifier from a second entity;
identifying, using the transaction identifier, a set of the personal information that is authorized to be shared with the second entity for the transaction; and
providing the set of the personal information to the second entity.

3. The method of claim 1, further comprising receiving an entity identification from the second entity, wherein the providing the set of the personal information occurs in response to verifying the identity of the entity.

4. The method of claim 3, wherein the entity identification is a digital certificate.

5. The method of claim 2, further comprising editing the transaction data to remove the second entity as an authorized entity.

6. The method of claim 2, further comprising:
generating a record in transaction ledger for the transaction in storage, the record identifying the second entity, the set of personal information, and a time of providing the set of personal data to the second entity.

7. The method of claim 2, wherein the second entity is a payment processor.

8. The method of claim 2, wherein the second entity is a shipper.

9. The method of claim 1, further comprising:
in response to receiving the request from the first entity, requesting authorization for the transaction from the user.

10. The method of claim 1, wherein the transaction identifier is encoded within a machine-readable image.

11. The method of claim 1, wherein the transaction identifier is devoid of personal information of the user.

12. The method of claim 1, further comprising associating the transaction identifier with the authorized entities and personal information in a storage.

13. A system comprising:
one or more processors; and
a computer readable storage medium communicatively coupled to the one or more processors, the computer readable storage medium containing program instructions executable by the one or more processors to cause the one or more processors to perform a method comprising:
receiving a request for a transaction identifier from a first entity to perform a transaction with a user;
determining transaction information for the transaction, the transaction information including authorized entities and sets of personal information of the user available to each of the authorized entities;
storing the transaction information;
generating the transaction identifier linked to the transaction; and
providing the transaction identifier to the first entity.

14. The system of claim 13, wherein the method further comprises:
receiving an entity identification from the second entity, wherein the providing the set of the personal information occurs in response to verifying the identity of the entity.

15. The system of claim 14, wherein the method further comprises:
generating a record in transaction ledger for the transaction in storage, the record identifying the second entity, the set of personal information, and a time of providing the set of personal data to the second entity.

16. The system of claim 13, wherein the transaction identifier is encoded within a machine-readable image.

17. The system of claim 13, wherein the transaction identifier is devoid of personal information of the user.

18. A computer program product comprising a computer readable storage medium containing program instructions executable by the one or more processors to cause the one or more processors to perform a method comprising:
receiving a request for a transaction identifier from a first entity to perform a transaction with a user;
determining transaction information for the transaction, the transaction information including authorized entities and sets of personal information of the user available to each of the authorized entities;
storing the transaction information;
generating the transaction identifier linked to the transaction; and
providing the transaction identifier to the first entity.

19. The computer program product of claim 18, wherein the method further comprises:
receiving an entity identification from the second entity, wherein the providing the set of the personal information occurs in response to verifying the identity of the entity.

20. The computer program product of claim 18, wherein the method further comprises:
generating a record in transaction ledger for the transaction in storage, the record identifying the second entity, the set of personal information, and a time of providing the set of personal data to the second entity.
